(19) United States
(12) Patent Application Publication
(10) Pub. No.: US 2024/0418831 A1
(43) Pub. Date: Dec. 19, 2024

(54) METHOD FOR ESTIMATING A DISTANCE BETWEEN A MOTOR VEHICLE AND AN EXTERNAL OBJECT, ASSOCIATED DEVICE, ASSOCIATED COMPUTER PROGRAM, AND ASSOCIATED MOTOR VEHICLE

(71) Applicant: Faurecia Clarion Electronics Europe, Paris (FR)

(72) Inventors: Julien KINTZINGER, Paris (FR); Julien MULLER, Paris (FR)

(21) Appl. No.: 18/742,911

(22) Filed: Jun. 13, 2024

(30) Foreign Application Priority Data
Jun. 13, 2023 (FR) FR 23 05971

(51) Int. Cl. G01S 7/48; G01S 17/42; G01S 17/86; G01S 17/931

(52) U.S. Cl. CPC G01S 7/4808; G01S 17/42; G01S 17/86; G01S 17/931

(57) ABSTRACT

A method and apparatus for estimating a distance between a motor vehicle and an external object, the vehicle being equipped with at least one camera for capturing digital images in a capture field, the vehicle having an onboard calculation device adapted to calculate estimated characteristics of at least one external object located in the capture field, including, for each external object, first estimated-position information about the object. A parameterized calculation engine takes as an input the estimated characteristics and provides second corrected-position information about the external object, used to estimate the distance between the motor vehicle and the external object. The values of the parameters of the calculation engine are obtained in a prior learning phase, taking into account, for each external object, the characteristics estimated on the basis of the digital images and reference points obtained by at least one remote detection sensor.

### TECHNICAL FIELD

The present invention relates to a method for estimating a distance between a motor vehicle and an object external to said vehicle, the motor vehicle being equipped with at least one camera configured to capture digital images in a capture field outside the motor vehicle.

The invention also relates to an associated device for estimating a distance between a motor vehicle and an object external to said vehicle, and to an associated non-transitory, computer-readable medium.

The invention further relates to a motor vehicle comprising a device for estimating a distance between the motor vehicle and an external object.

The invention is in the field of safe driving of motor vehicles and finds applications in particular in the field of automatic driving of autonomous motor vehicles.

### BACKGROUND

Indeed, in the field of safe driving of motor vehicles, and in particular in automatic or semi-automatic driving, it is necessary to identify and position spatially, over time, any object external to the vehicle in question, also referred to as the “ego vehicle”, so as to avoid any collision.

In particular, an object external to the vehicle, for example an external moving object, becomes an obstacle if it follows a trajectory likely to intersect the trajectory of the motor vehicle in question.

Such detection of a risk of collision is also useful in driving assistance systems, even for motor vehicles with a driver on board.

A critical problem for safety is the preemptive detection of obstacles in the path of a moving vehicle, making it possible to take corrective measures so that the vehicle does not hit these obstacles.

Motor vehicles are equipped with sensors, in particular image sensors such as one or more cameras configured to capture digital images, as well as optionally radar sensors making it possible to detect external objects, which are potential obstacles, in an external environment of the motor vehicle in question, using radar technology.

Automotive driving assistance systems are known, called ADAS systems (Advanced Driver Assistance Systems), as are systems for obstacle identification and avoidance for autonomous vehicles.

A system is known for detecting external objects and estimating the characteristics of each detected external object, including positional information within a given plane of representation, from the digital images captured by a camera or several onboard cameras, by applying processing of the captured digital images. However, the positioning reliability obtained by such processing of digital images is not always sufficient, which may, in some cases, prove critical.

There is a need to improve the accuracy of the positioning of detected external objects relative to the motor vehicle in question, while avoiding high extra calculation costs.

### SUMMARY

To this end, according to one aspect, the invention proposes a method for estimating a distance between a motor vehicle and an external object, the motor vehicle being equipped with at least one camera configured to capture digital images in a capture field outside the motor vehicle, the vehicle comprising an onboard calculation device adapted to process said captured digital images and calculate estimated characteristics of at least one external object located in said capture field, said estimated characteristics comprising, for each external object, first estimated-position information about said object in a coordinate system wherein said motor vehicle is also positioned. This method comprises the implementation, by a processor of said onboard calculation device:
for the or each external object, providing said characteristics estimated from the captured digital images as an input for a parameterized calculation engine, trained by machine learning in a prior learning phase, said calculation engine being configured to provide second corrected-position information about said external object, and
estimating a distance between the motor vehicle and the external object as a function of a current position of the motor vehicle and said second corrected-position information.

In the prior learning phase, machine learning is implemented of the values of the parameters of said calculation engine, taking into account, for each external object, the characteristics of said external object estimated on the basis of the captured digital images and reference points obtained by at least one remote detection sensor.

Advantageously, the method implements a parameterized calculation engine, configured to calculate corrected-position information, this calculation engine being trained by machine learning to provide such corrected-position information, from reference points obtained by at least one onboard remote detection sensor in addition to the characteristics estimated from the digital images.

The method for estimating a distance between a motor vehicle and an external object can also have one or more of the features hereunder, taken independently or in all technically conceivable combinations

At least one remote detection sensor providing said reference points is a LiDAR sensor.

The motor vehicle is equipped with at least one radar sensor providing instantaneous radar points, said instantaneous radar points being further provided as an input for said calculation engine.

Machine learning of the values of the parameters of the calculation engine also takes into account a speed of movement of said external object, and wherein the calculation engine takes as an input an instantaneous speed of said external object.

The instantaneous speed of said external object is calculated from said captured digital images.

The instantaneous speed of said external object is obtained from radar points provided by at least one onboard radar sensor.

The estimated characteristics further comprise, for each external object, a classification of said external object into a class of objects from among a plurality of predetermined classes, said classification being provided as an input for said calculation engine.

The estimated features comprise, for a detected external object, a rectangular frame wherein said external object is located, said first estimated-position information including coordinates in said coordinate system of at least two corners of said rectangular frame.

The prior learning phase comprises, for at least one vehicle and at least one object external to said vehicle, the receipt of learning data comprising estimated characteristics of the external object and a plurality of points obtained by at least one onboard remote detection sensor, and then the extraction, from the plurality of remote detection points, of at least one reference point associated with said external object, said reference point being, for a given external object, the closest remote detection point, according to a chosen metric, of said vehicle and of a corner of the frame representing said external object.

According to another aspect, the invention relates to a device for estimating a distance between a motor vehicle and an external object, the motor vehicle being equipped with at least one camera configured to capture digital images in a capture field outside the motor vehicle, the vehicle comprising an onboard calculation device adapted to process said captured digital images and calculate estimated characteristics of at least one external object located in said capture field, said estimated characteristics comprising, for each external object, first estimated-position information about said object in a coordinate system wherein said motor vehicle is also positioned, the device comprising a processor configured to implement:
for the or each external object, a module for providing said characteristics estimated on the basis of the captured digital images as an input for a parameterized calculation engine, trained by machine learning in a prior learning phase, said calculation engine being configured to provide second corrected-position information of said external object, and
a module for estimating a distance between the motor vehicle and the external object as a function of a current position of the motor vehicle and said second corrected-position information,
values of the parameters of said calculation engine being obtained by implementing, in the prior learning phase, machine learning of the values of the parameters of said calculation engine, taking into account, for each external object, the characteristics of said external object estimated on the basis of the captured digital images and of reference points obtained by at least one remote detection sensor.

The device for estimating a distance between a motor vehicle and an external object is configured to implement the method for estimating a distance between a motor vehicle and an external object as briefly described above, according to all its variants.

According to another aspect, the invention relates to an information recording medium, on which software instructions are stored for the execution of a method for estimating a distance between a motor vehicle and an external object as briefly described above, when these instructions are executed by a programmable electronic device.

According to another aspect, the invention also relates to a non-transitory, computer-readable medium having stored thereon software instructions which, when executed by a programmable electronic device, implement such a method for estimating a distance between a motor vehicle and an external object as briefly described above

According to another aspect, the invention relates to a motor vehicle equipped with at least one camera configured to capture digital images in a capture field outside the motor vehicle, the vehicle comprising an onboard calculation device adapted to process said captured digital images and calculate estimated characteristics of at least one external object located in said capture field, said estimated characteristics comprising, for each external object, first estimated-position information about said object in a coordinate system wherein said motor vehicle is also positioned, and comprising a device for estimating a distance between said motor vehicle and an external object as briefly described above.

### BRIEF DESCRIPTION OF THE DRAWINGS

The invention will become clearer on reading the following description, given solely by way of non-limiting example, and made with reference to the drawings, wherein:

FIG. 1 is a schematic representation of a plan view of a motor vehicle equipped with cameras and radar sensors and external objects and detected radar points;

FIG. 2 is a schematic representation of a system for estimating a distance between a motor vehicle and an external object;

FIG. 3 is a flowchart of the main steps of a method for estimating a distance between a motor vehicle and an external object, in the operating phase, according to one embodiment;

FIG. 4 is a flowchart of the main steps of a method for estimating a distance between a motor vehicle and an external object, in the learning phase, according to one embodiment;

FIG. 5 is a schematic example of the correction of the position of objects external to a motor vehicle in question.

### DETAILED DESCRIPTION

Various embodiments of the invention may be applied to different types of motor vehicle, one with a driver on board, a semi-autonomous one, or an autonomous one.

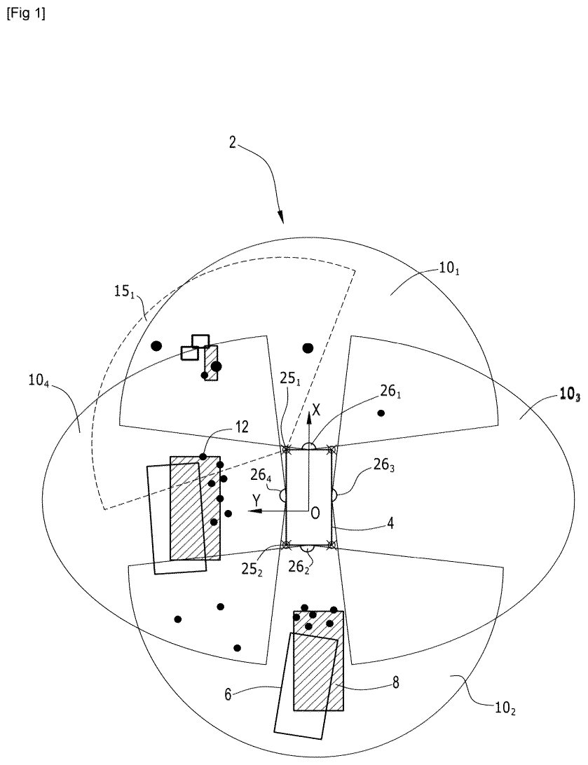

FIG. 1 is a schematic plan view 2 of a motor vehicle 4 (which is the vehicle in question or ego vehicle), and a plurality of external objects

The view 2 is a schematic representation in a plane of representation, at a given point in time, it being understood that when the vehicle 4 is moving, a succession of such representations 2 is obtained.

For example, the vehicle 4 is moving along a road, not shown in FIG. 1.

The motor vehicle 4 is represented schematically by a rectangular frame. The plane of representation of FIG. 1 is a plane in plan view of the scene.

Frames 6 are also shown in the figure, these frames being representative of the external objects, the external objects being detected by a detection method and categorized into a plurality of predetermined categories

Each frame, dimensioned as a function of the category of the object, is positioned as a function of the position and orientation of the detected object, the frame being placed as close as possible to the contours of the object detected in the plane of representation.

The frames 6 are preferably rectangular in shape. Thus, the position of such a rectangular frame is easy to express, for example via the position of the corners or the position of the geometric center and the dimensions of the sides. The position of a point (e.g. corner or geometric center) is for example expressed by coordinates in a coordinate system (or reference system) of the plane of representation, for example a scalar coordinate system (O, X, Y) associated with the motor vehicle as shown in FIG. 1.

In addition to the frames 6 indicative of the estimated position of the external objects, corresponding external objects 8 are represented by hatched areas in FIG. 1. The hatched areas represent the actual position (or ground truth) of the external objects.

External objects are, for example, other motor vehicles, bicycles, or pedestrians, or fixed roadside objects.

The motor vehicle 4 is equipped with several sensors, e.g. with at least one digital camera, preferentially a two-dimensional digital camera configured to capture two-dimensional digital images of the external environment of the vehicle at successive points in time.

In the example shown, the vehicle 4 is equipped with four cameras 26, positioned respectively at the front, at the rear, on the right-hand side panel, and on the left-hand side panel of the vehicle.

For example, considering that the front of the vehicle 4 is indicated by the X-axis, the cameras are monocular cameras, each camera having an associated field of view 101 to 104:101 is the field of view of the camera 261 located at the front of the vehicle 4, 102 is the field of view of the camera 262 located at the rear of the vehicle 4, 103 is the field of view of the camera 263 located on the right-hand side panel of the vehicle 4, 104 is the field of view of the camera 264 located on the left-hand side panel of the vehicle 4.

In addition, the vehicle 4 is equipped with at least one radar sensor 25, and more particularly a plurality of radar sensors 25 in the example of FIG. 1, for example four radar sensors located respectively at the front, at the rear, and on the side panels of the vehicle. Each of the radar sensors 25 has an associated capture field 15. FIG. 1 shows a sensor 251 and the associated capture field 151.

More generally, the onboard sensors 25 are remote detection sensors, in particular radar or LiDAR sensors.

Points resulting from the detection by the radar sensors, called radar points, referenced by the reference sign 12, are also obtained and positioned by their position (e.g. coordinates in the chosen coordinate system) detected in the plane of representation.

The method makes it possible to correct first estimated-position information about the objects external to the vehicle, on the basis of processing of digital images, for example obtained by onboard monocular cameras, in order to obtain second corrected-position information closer to the actual position of the external objects 8.

Thus, the accuracy of the estimation of the distance between each external object and the vehicle 4 in question is improved, which makes it possible to improve the prevention of a risk of collision.

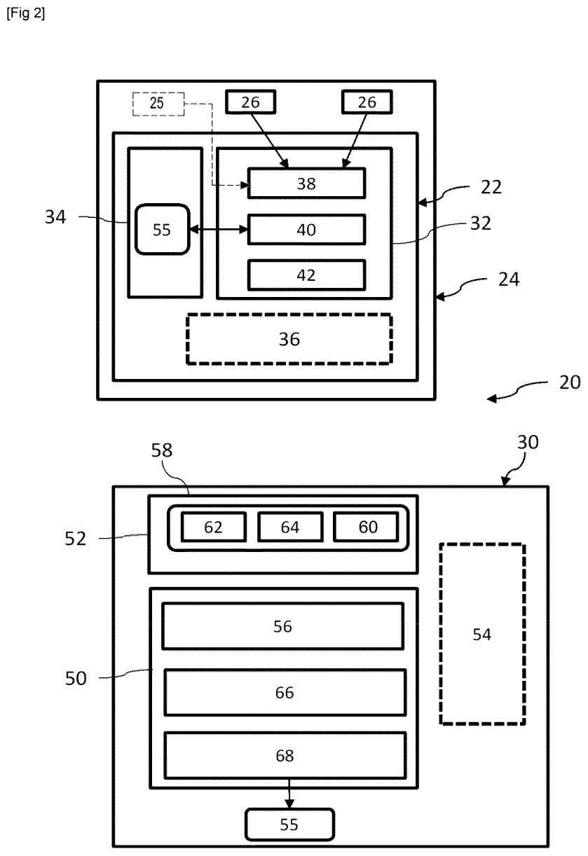

FIG. 2 schematically shows a system for estimating the distance between a motor vehicle and an external object.

The system of course applies to estimation of the distance between the motor vehicle and each external object detected in an environment close to the vehicle, for example within a radius of 80 meters around the vehicle, preferably within a radius of 20 meters

The system 20 comprises, on the one hand, a device 22 for estimating the distance between a motor vehicle 24 and an external object (not shown in FIG. 2).

The device 22 is a programmable electronic device which is a calculation device on board the vehicle 24, for example an onboard computer.

The vehicle 24 further comprises one or more cameras 26, which are for example image-capture cameras of the monocular camera type.

Optionally, the vehicle 24 carries one or more radar sensors 25.

The system 20 comprises, on the other hand, an electronic calculation device 30

This electronic calculation device 30 is, for example, located in a calculation center, i.e. it is not on board.

The device 22 implements estimation of the distance between the vehicle 24 in question and an external object in an operating phase, implemented in the vehicle 24 under conditions of use of this vehicle, i.e. when it is moving between a point A and a point B.

In the example of FIG. 2, the electronic device 22 for estimating a distance between the vehicle 24 and an external object comprises an information processing unit, formed for example from a processor 32 and an electronic memory unit 34 associated with the processor 32. The electronic device 22 further comprises, optionally, a communication unit 36 configured to communicate with a remote device in accordance with a chosen communication protocol.

This electronic device 22 comprises a module 38 for processing captured digital images, which provides estimated characteristics of at least one object external to the vehicle 24, these estimated characteristics comprising, for each external object, estimation of first estimated-position information in a chosen plane of representation.

For example, the chosen plane of representation is a plane in plan view, and the first estimated-position information comprises the coordinates of the respective corners of a rectangular frame of the detected external object, in the chosen coordinate system.

The estimated characteristics also comprise a classification of the external object from among a plurality of predetermined classes.

For example, the plurality of predetermined classes includes the following classes: {pedestrian, bicycle, motorcycle, car, truck}.

The electronic device 22 further comprises a module 40 for implementing a parameterized calculation engine 55, trained by machine learning in a prior learning phase. For each detected external object, input data comprising the characteristics estimated by the module 38 are provided as an input for the calculation engine, this calculation engine being configured to calculate second corrected-position information about the external object.

Optionally, the input data include instantaneous radar points, obtained by the onboard radar sensor(s).

In addition, in embodiments, the input data include an estimated speed of the vehicle 24. The estimated speed is, for example, calculated from instantaneous radar points.

As a variant, the estimated speed is calculated from successive digital images by object tracking between successive images.

The electronic device 22 also comprises a module 42 for estimating the distance between each detected external object and the motor vehicle 24 as a function of a current position of the vehicle and of the second corrected-position information.

In one embodiment, the modules 38, 40, 42 each take the form of software, or a software block, executable by the processor 32.

The memory 34 of the electronic device 22 is then able to store software for processing captured digital images in order to calculate estimated characteristics of at least one object external to the vehicle 24, software for implementing a calculation engine, and software for estimating the distance between each detected external object and the motor vehicle 24.

The processor is then able to execute each piece of software from the software for processing captured digital image in order to calculate estimated characteristics of at least one object external to the vehicle 24, the software for implementing a calculation engine, and the software for estimating the distance between each detected external object and the motor vehicle 24.

In a variant which is not shown, the modules 38, 40, and 42 each take the form of a programmable logic component, such as an FPGA (Field Programmable Gate Array), or the form of an integrated circuit, such as an ASIC (Application Specific Integrated Circuit).

In the embodiment in which the modules 38, 40, and 42 include executable software instructions, in the form of a computer program, also called a computer program product, this program is further able to be recorded (stored) on a medium, not shown, which is computer-readable. The computer-readable medium is, for example, a non-transitory medium able to store electronic instructions and to be coupled to a bus of a computer system. By way of example, the non-transitory, computer-readable medium is an optical disk, a magneto-optical disk, a ROM memory, a RAM memory, any type of non-volatile memory (for example FLASH or NVRAM), or a magnetic card.

The electronic calculation device 30 implements a prior phase of learning the parameters of the calculation engine 40 using machine learning.

Preferably, the calculation engine 40 implements a prediction model trained by the XGBoost (eXtreme Gradient Boosting) machine training method, known in the field of artificial intelligence.

Machine learning is carried out on learning input data comprising correction information, in the form of reference points associated with the frames representative of the external objects.

Thus, in one embodiment, the calculation engine 40 is trained in the learning phase to provide as an output second positional information corrected as a function of first positional information obtained as the input, and reference points.

The electronic device 30 comprises an information processing unit, formed for example from a processor 50 and an electronic memory unit 52 associated with the processor 50. The electronic device 30 further comprises, optionally, a communication unit 54 configured to communicate with a remote device in accordance with a chosen communication protocol.

This electronic device 30 comprises a module 56 for receiving learning data 58, for example stored in the electronic memory 52.

In a variant, the learning data 58 are received via the communication unit 54 of one or more external devices.

The learning data 58 are provided for a vehicle and an object external to the vehicle, at successive points in time within a processing time interval, and comprise: characteristics 60 estimated by image processing, comprising first information on position in the coordinate system; radar points 62 obtained by at least one radar sensor on board the vehicle and defined by coordinates in the coordinate system, and remote detection points 64 obtained by at least one onboard remote detection sensor, preferably a LiDAR sensor.

The electronic device 30 also comprises a module 66 for extracting reference points, which are associated with the external object and which are tracked during a time interval, as explained in more detail below.

Finally, the electronic device 30 comprises a module 68 for the machine learning of the values of the parameters of the calculation engine 40 in order to provide positions which are corrected with regard to the estimated positions using the reference points. In particular, the module 68 outputs values for the parameters 55 of the calculation engine 40.

In one embodiment, the modules 56, 66, 68 each take the form of software, or a software block, executable by the processor 50.

The memory 52 of the electronic device 30 is then able to store software for receiving learning data, software for extracting, from the plurality of remote detection points, reference points which are associated with the external object and which are tracked for a time interval, and software for the machine learning of the values of the parameters of the calculation engine 40. The processor 50 is then able to execute each of these pieces of software.

In a variant which is not shown, the modules 56, 66, 68 each take the form of a programmable logic component, such as an FPGA (Field Programmable Gate Array), or the form of an integrated circuit, such as an ASIC (Application Specific Integrated Circuit).

In the embodiment in which the modules 56, 66, 68 include executable software instructions, in the form of a computer program, also called a computer program product, this program is further able to be recorded (stored) on a computer-readable medium (not shown). The computer-readable medium is, for example, a non-transitory medium able to store electronic instructions and to be coupled to a bus of a computer system. By way of example, the non-transitory, computer-readable medium is an optical disk, a magneto-optical disk, a ROM memory, a RAM memory, any type of non-volatile memory (for example FLASH or NVRAM), or a magnetic card.

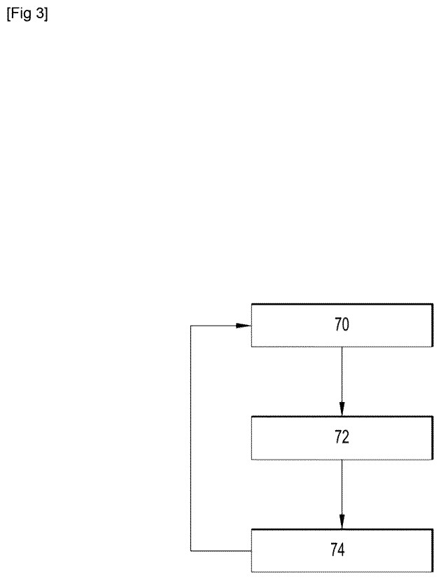

FIG. 3 is a block diagram of the main steps of a method for estimating a distance between a motor vehicle and an external object, according to one embodiment, in the operating phase, implemented by an electronic device 22 on board an ego motor vehicle, simply called a vehicle below.

The method comprises a step 70 of capturing digital images and calculating, for each detected external object, estimated characteristics comprising first estimated-position information, and optionally a classification of the detected object into a class from among a plurality of predetermined classes.

This step 70 can be implemented, in certain embodiments, by a specific information processing unit associated with the onboard camera(s).

For example, step 70 implements image segmentation or any other image processing method for detecting objects in the images.

The method comprises a step 72, implemented for each detected external object, of providing the estimated characteristics for the external object in question as an input for the corrected-position calculation engine, previously trained by learning, and executing this calculation engine

For the external object in question, a second corrected position in the chosen coordinate system is obtained as the output of step 72.

For example, the chosen coordinate system is a reference system of the chosen plane of representation which is, for example, a plane parallel to the plane tangential to the road along which the vehicle is driving.

For example, the vehicle and the external object are each represented by a rectangular frame in this plane.

The first position of the external object is defined by the respective positions of the corners of the frame associated with the external object, as shown in FIG. 1.

In one embodiment, the current position of the vehicle is, for example, the position (0,0) in the chosen coordinate system, as shown in FIG. 1.

A second corrected position of the external object is provided as the output of step 72, the correction consisting, for example, of a displacement vector and an orientation correction.

The method then comprises a step 74 of estimating the distance between the external object and the vehicle, as a function of the current position of the vehicle (at the current time t) and the second corrected position of the external object.

Advantageously, when the reference system is associated with the vehicle, the distance is obtained directly from the second corrected position in this reference system.

According to one variant, the distance between the point of the rectangular frame which is associated with the external object, according to the second corrected position, and is closest to the rectangular frame associated with the vehicle is evaluated.

Steps 70 to 74 are repeated for successive points in time in a time interval.

The result of the estimation of the distance between the vehicle and the external object is provided to an automatic or semi-automatic guidance application of the vehicle.

As a variant, this distance is compared with a proximity threshold, and an alert to the driver is raised if the proximity threshold is reached (audio, visual or other alert)

According to variants, when the vehicle is equipped with radar sensors, the positions of instantaneous radar points, obtained in real time by the radar sensors, are provided as an input for step 72.

According to variants, the estimated characteristics further comprise an estimated speed of the external object. Taking into account the estimated speed of the external object, previously used in the phase of learning the parameters of the corrected-position calculation engine, also makes it possible to improve the accuracy of the second corrected position of the external object. For example, the estimated speed of the external object is calculated from the digital images captured successively or from the instantaneous radar points.

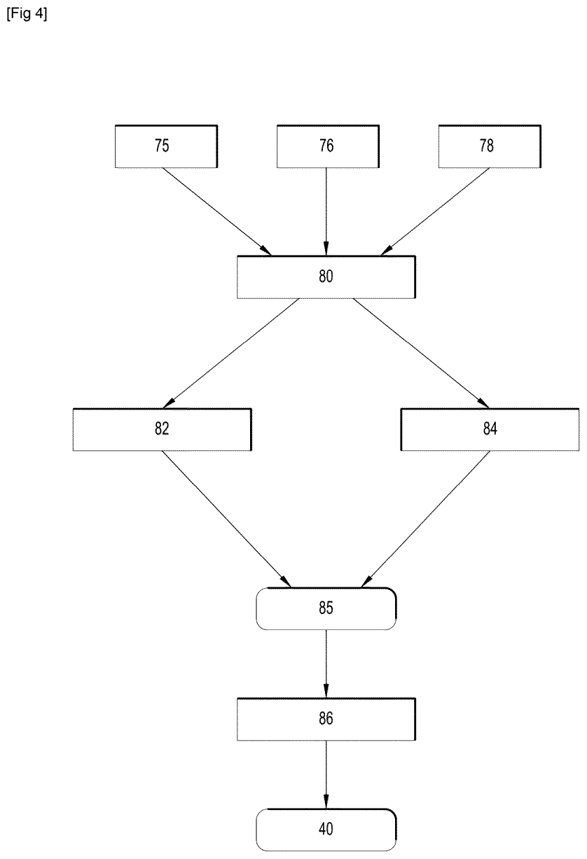

FIG. 4 is a block diagram of the main steps of a method for estimating a distance between a motor vehicle and an external object, in the learning phase, implemented by an electronic device 30, according to one embodiment.

The method comprises, for each external object, a step 80 of receiving the learning data comprising: estimated characteristics 76 of the external object from the captured digital images, which are for example two-dimensional digital images, of instantaneous radar points 78 obtained by at least one radar sensor; and instantaneous remote detection points 75 obtained by at least one remote detection sensor, for example a LIDAR sensor

Advantageously, the LiDAR technology makes it possible to obtain a large number of points, and consequently good positioning accuracy.

The estimated characteristics 76 comprise the estimated position of the external object, in particular the size and orientation of the frame associated with the object.

The method comprises a step 82 of extracting reference points from the instantaneous remote detection points.

Step 82 comprises, in one embodiment:
A) grouping, also called clustering, of the remote detection points (e.g. LiDAR points) to form groups (or clusters) of points. For example, the DBSCAN (density-based spatial clustering of applications with noise) algorithm is applied;
B) for each of the clusters, determination of the end points (top, bottom, right, left). The number of end points is equal to 2 when the points are aligned, but it may be equal to 3 or 4 depending on the scenarios;
C) for each cluster, identification of the end point closest to the vehicle;
D) for each external object, determining the corner of the frame representative of the object closest to the vehicle, and associating this corner with the closest end point obtained in step C) as a reference point.

The proximity is evaluated according to a chosen metric, for example the Euclidean distance.

Thus, for each detected external object, a reference point is associated with one of the corners of the frame defining the object, which makes it possible to make a correction using the position of the frame in translation.

In addition, the orientation of the frame defining the detected external object is either obtained from the image processing or obtained by implementing movement tracking on the basis of the remote detection points on successive image frames, which makes it possible to determine the orientation of the frame.

According to variants, several reference points are associated with the frame of a detected external object.

Optionally, the method comprises an estimation 84 of the speed of the external object, making it possible to obtain an estimated speed of the external object

According to one embodiment, the estimated speed is obtained from the successive digital images captured by the onboard cameras.

In a variant, the estimated speed is obtained from the positions of instantaneous radar points

Steps 80 to 84 are iterated for one or more vehicles in question and several external objects, so as to form a learning database 85.

The method next comprises implementation 86 of machine learning of the parameters of the calculation engine 40 from the learning database 85.

For example, step 86 implements the XGBoost supervised training method on a chosen architecture prediction model.

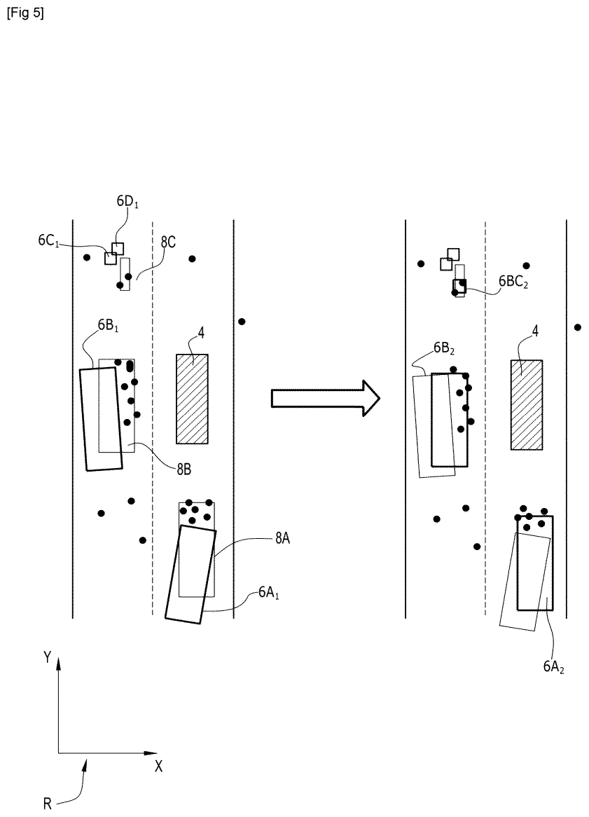

FIG. 5 schematically shows an application scenario.

Shown in the left-hand part of the figure, in the plane of representation in plan view, are the ego motor vehicle 4, as well as rectangular frames of the detected external objects in their first estimated positions: a frame 6A₁ corresponding to a first external vehicle, for example an automobile, located behind the vehicle 4, in the same traffic lane; a frame 6B₁ corresponding to a second external vehicle, for example an automobile, located substantially parallel to the vehicle 4, in a parallel traffic lane; two frames 6C₁, 6D₁ located in front of the vehicle 4, on the same traffic lane as the second detected external vehicle.

The first positions of the respective frames, for example given by the position in the chosen coordinate system, for example the reference system associated with the vehicle 4 as shown in FIG. 1, and the orientation of each frame relative to one of the axes of the coordinate system, considering that the length and width dimensions are known, for example as a function of the associated class.

Radar points are also positioned in the plane of representation.

Shown in the right-hand part of the figure, in the plane of representation in plan view, are the ego motor vehicle 4, as well as rectangular frames of the detected external objects in their second corrected positions: the frame 6A₂ corresponding to the first external vehicle; the frame 6B₂ corresponding to the second external vehicle; the frame 6C₂ corresponding to a third external vehicle, for example a 2-wheeled vehicle.

The gray areas 8A, 8B, 8C shown correspond to the “true” vehicles present.

Thus, it can be observed on the right-hand part of the figure that the positions of the vehicles 6A₁, 6B₁, and 6C₁ are corrected to 6A₂, 6B₂, and 6C₂, these corrected positions correspond more accurately to the actual positions 8A, 8B, and 8C.

1. A method for estimating a distance between a motor vehicle and an external object, the motor vehicle being equipped with at least one camera configured to capture digital images in a capture field outside the motor vehicle, the vehicle comprising an onboard calculation device adapted to process said captured digital images and calculate estimated characteristics of at least one external object located in said capture field, said estimated characteristics comprising, for each external object, first estimated-position information about said object in a coordinate system wherein said motor vehicle is also positioned, the method comprising the implementation, by a processor of said onboard calculation device:
for each external object, providing said characteristics estimated on the basis of the captured digital images as an input for a parameterized calculation engine, trained by machine learning in a prior learning phase, said calculation engine being configured to provide second corrected-position information about said external object, and
estimating a distance between the motor vehicle and the external object as a function of a current position of the motor vehicle and said second corrected-position information,
and wherein, in the prior learning phase, machine learning is implemented of the values of the parameters of said calculation engine, taking into account, for each external object, the characteristics of said external object estimated on the basis of the captured digital images and reference points obtained by at least one remote detection sensor.

2. The method according to claim 1, wherein at least one remote detection sensor providing said reference points is a LIDAR sensor.

3. The method according to claim 1, the motor vehicle being equipped with at least one radar sensor providing instantaneous radar points, said instantaneous radar points being further provided as an input for said calculation engine.

4. The method according to claim 1, wherein the machine learning of the values of the parameters of the calculation engine also takes into account a speed of movement of said external object, and wherein the calculation engine takes as an input an instantaneous speed of said external object.

5. The method according to claim 4, wherein the instantaneous speed of said external object is calculated on the basis of said captured digital images.

6. The method according to claim 4, wherein the instantaneous speed of said external object is obtained on the basis of radar points provided by at least one onboard radar sensor.

7. The method according to claim 1, wherein said estimated characteristics further comprise, for each external object, a classification of said external object into a class of objects from among a plurality of predetermined classes, said classification being provided as an input for said calculation engine.

8. The method according to claim 1, wherein the estimated characteristics comprise, for a detected external object, a rectangular frame wherein said external object is located, said first estimated-position information comprising coordinates in said coordinate system of at least two corners of said rectangular frame.

9. The method according to claim 8, wherein the prior learning phase comprises, for at least one vehicle and at least one object external to said vehicle, the receipt of learning data comprising estimated characteristics of the external object and a plurality of points obtained by at least one onboard remote detection sensor, and then the extraction, from the plurality of remote detection points, of at least one reference point associated with said external object, said reference point being, for a given external object, the closest remote detection point, according to a chosen metric, of said vehicle and of a corner of the frame representing said external object.

10. A device for estimating a distance between a motor vehicle and an external object, the motor vehicle being equipped with at least one camera configured to capture digital images in a capture field outside the motor vehicle, the vehicle comprising an onboard calculation device adapted to process said captured digital images and calculate estimated characteristics of at least one external object located in said capture field, said estimated characteristics comprising, for each external object, first estimated-position information about said object in a coordinate system wherein said motor vehicle is also positioned, the device comprising a processor configured to implement:
for each external object, a module for providing said characteristics estimated on the basis of the captured digital images as an input for a parameterized calculation engine, trained by machine learning in a prior learning phase, said calculation engine being configured to provide second corrected-position information of said external object, and
a module for estimating a distance between the motor vehicle and the external object as a function of a current position of the motor vehicle and said second corrected-position information,
values of the parameters of said calculation engine being obtained by implementing, in the prior learning phase, machine learning of the values of the parameters of said calculation engine taking into account, for each external object, the characteristics of said external object estimated on the basis of the captured digital images and of reference points obtained by at least one remote detection sensor.

11. A motor vehicle equipped with at least one camera configured to capture digital images in a capture field outside the motor vehicle, the vehicle comprising an onboard calculation device adapted to process said captured digital images and calculate estimated characteristics of at least one external object located in said capture field, said estimated characteristics comprising, for each external object, first estimated-position information about said object in a coordinate system wherein said motor vehicle is also positioned, and comprising a device for estimating a distance between said motor vehicle and an external object according to claim 10.

12. A non-transitory, computer-readable medium having stored thereon software instructions which, when executed by a programmable electronic device, implement the method for estimating a distance between a motor vehicle and an external object according to claim 1.
